(19) United States
(12) Patent Application Publication
(10) Pub. No.: US 2015/0212588 A1
(43) Pub. Date: Jul. 30, 2015

(54) Keyboard Cover For A Tablet Computer

(71) Applicant: Fuhu Holdings, Inc., El Segundo, CA (US)

(72) Inventor: Robb Fujioka, Manhattan Beach, CA (US)

(73) Assignee: Fuhu Holdings, Inc., El Segundo, CA (US)

(21) Appl. No.: 14/606,965

(22) Filed: Jan. 27, 2015

Related U.S. Application Data
(60) Provisional application No. 61/932,031, filed on Jan. 27, 2014.

(51) Int. Cl. G06F 3/02

(52) U.S. Cl. CPC G06F 3/0219; G06F 3/0227

(57) ABSTRACT

An apparatus for a tablet computer is disclosed. According to one embodiment, the apparatus includes a back support, a brace, a base portion, and a hand rest. The brace shares a first flexible strip with the back support, the base portion shares a second flexible strip with the brace, and the hand rest shares a third flexible strip with the base portion. The back support is rotatable along the first flexible strip relative to the brace, the brace is rotatable along the second flexible strip relative to the base portion, and the hand rest is rotatable along the third flexible strip relative to the base portion. The base portion includes a keyboard, a battery, and internal circuitry suitable for interfacing with the tablet computer. The hand rest includes a touch pad. The apparatus is configurable in a desktop configuration, a tablet configuration, and a portability configuration.

### CROSS REFERENCES

This application claims the benefit of and priority to U.S. Provisional Application No. 61/932,031, filed on Jan. 27, 2014, entitled “Keyboard Cover for a Tablet Computer,” the disclosure of which is hereby incorporated by reference in its entirety.

### FIELD

The field of the present disclosure generally relates to peripheral devices and accessories for a tablet computer, more particularly, to a keyboard cover for a tablet computer.

### BACKGROUND

One of the fastest growing markets in the computer industry is the tablet computer. Similar in appearance to cellular phones or mobile devices, tablet computers are typically characterized by a display screen bordered by an exterior case that houses interior electronics. The display screen generally is a touch screen variety that enables a user to operate and interact with the tablet computer by directly touching the display screen rather than using a peripheral input device such as a mouse and/or a keyboard.

A drawback to tablet computers, however, is that they must be held in a position suitable for viewing while interacting with the touch screen. A user of a tablet computer usually holds the tablet computer in one hand while operating the touch screen with the other free hand. This hand-held approach does not allow the user to operate the tablet computer with both hands. Continuously holding the tablet computer also makes working with other resources, such as reference materials and a pen, awkward because the user must put down the tablet computer or continue holding the tablet computer while attempting to use the other resources with the free hand. In an attempt to liberate both hands when interacting with the tablet computer, the user may use a hands-free support to keep the tablet computer in a desired position for viewing and interacting. Oftentimes, the hands-free support props up the rear side of the tablet computer on a book, a stack of folders, or the like. A drawback to propping up rear side of the tablet computer is that the tablet computer may slide off the support, potentially damaging the touch screen or the sensitive electronics within the tablet computer. Moreover, supporting the tablet computer on a book becomes inconvenient because the user may need to open the book while using the tablet computer.

Another drawback to tablet computers is that they have only an on-screen virtual keyboard that lacks the tactile feedback of physical keys of a mechanical keyboard. When the on-screen virtual keyboard is coupled with the above-mentioned hand-held approach that requires the user to hold the tablet computer in one hand, the user is often reduced to typing by pointing at the virtual keyboard with a finger. Moreover, when the user holds the tablet computer with one hand, the virtual keyboard may no longer be in a position suitable for touch-based typing with both hands. In some instances, an external keyboard may be connected to the tablet computer, but the portability is reduced because the user must carry the keyboard in addition to the tablet computer.

### SUMMARY

An apparatus configured to support, protect, and operate with a tablet computer is disclosed. According to one embodiment, the apparatus includes a back support, a brace, a base portion, and a hand rest. The brace shares a first flexible strip with the back support, the base portion shares a second flexible strip with the brace, and the hand rest shares a third flexible strip with the base portion. The back support is rotatable along the first flexible strip relative to the brace, the brace is rotatable along the second flexible strip relative to the base portion, and the hand rest is rotatable along the third flexible strip relative to the base portion. The base portion includes a keyboard, a battery, and internal circuitry suitable for interfacing with the tablet computer. The hand rest includes a touch pad. The apparatus is configurable in a desktop configuration, a tablet configuration, and a portability configuration.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles and features explained herein may be employed in various and numerous embodiments.

### BRIEF DESCRIPTION OF THE DRAWINGS

The drawings refer to embodiments of the present disclosure in which:

FIG. 1 is a front perspective view of an exemplary desktop configuration of a keyboard cover, according to one embodiment;

FIG. 2 is a side view illustrating the exemplary desktop configuration of the keyboard cover shown in FIG. 1, according to one embodiment;

FIG. 3 is a rear perspective view illustrating the exemplary desktop configuration of the keyboard cover shown in FIG. 1, according to one embodiment;

FIG. 4 is an upper perspective view of an exemplary portability configuration of a keyboard cover, according to one embodiment; and

FIG. 5 is a lower perspective view illustrating the exemplary portability configuration of the keyboard cover shown in FIG. 4, according to one embodiment.

While the present disclosure is subject to various modifications and alternative forms, specific embodiments thereof have been shown by way of example in the drawings and will herein be described in detail. The present disclosure should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the present disclosure may be practiced without these specific details. Further, specific numeric references such as “first flexible strip,” may be made. However, the specific numeric reference should not be interpreted as a literal sequential order but rather interpreted that the “first flexible strip” is different from a “second flexible strip.” Thus, the specific details set forth are merely exemplary. The specific details may be varied from and be contemplated to be within the spirit and scope of the present disclosure.

The present disclosure describes a keyboard cover configured to support, protect, and operate with a tablet computer. According to one embodiment, the keyboard cover includes a back support, a brace, a base portion, and a hand rest. The brace shares a first flexible strip with the back support, the base portion shares a second flexible strip with the brace, and the hand rest shares a third flexible strip with the base portion. The back support is rotatable along the first flexible strip relative to the brace, the brace is rotatable along the second flexible strip relative to the base portion, and the hand rest is rotatable along the third flexible strip relative to the base portion. The base portion includes a keyboard, a battery, and internal circuitry suitable for interfacing with the tablet computer. The hand rest includes a touch pad. The keyboard cover is configurable in a desktop configuration, a tablet configuration, and a portability configuration.

According to one embodiment, the keyboard cover further includes a hand rest that shares a third flexible strip with the base portion. The hand rest is rotatable along the third flexible strip relative to the base. The hand rest includes a touch pad that enables the user to interact with the tablet computer using a finger. Preferably, the keyboard cover is made of a pliable material, such as soft polyurethane, that facilitates bending the flexible strips and is suitable for protecting the tablet computer.

According to one embodiment, the keyboard cover can be configured in a variety of configurations including, but not limited to, a desktop configuration, a tablet configuration, and a portability configuration. In a desktop configuration, the back support and the brace of the keyboard cover support the rear side of the tablet computer while the base portion of the keyboard cover supports a lower portion of the tablet computer. In the desktop configuration, the tablet computer is held in a position suitable for viewing and interacting with the display screen while facilitating the user's typing on the keyboard.

In a portability configuration, the lower portion of the tablet computer is positioned against the inside of the second flexible strip, and the display screen faces toward the keyboard. The hand rest is folded onto the back support using the third flexible strip. The hand rest is held against, or fastened to, the back support to maintain the portability configuration.

In a tablet configuration, the lower portion is positioned toward the third flexible strip, the display screen faces away from the keyboard, and the hand rest is folded under the base portion. The keyboard cover may include a sensor configured to detect when the tablet computer and the keyboard cover are placed into the tablet configuration. The sensor may switch the display screen between a landscape format and a portrait format depending on the orientation of the tablet computer while being held by the user. The sensor may be configured to turn off the tablet computer, the keyboard, and the touch pad when the tablet computer and the keyboard cover are put into the portability configuration.

According to one embodiment, the base portion includes a keyboard, a battery, and internal circuitry suitable for interfacing with the tablet computer. In one embodiment, the battery within the base portion is coupled with an internal battery of the tablet computer to increase the operating time of the tablet computer between charging sessions.

According to one embodiment, the keyboard cover includes internal circuitry that is suitable for establishing a wireless connection with the tablet computer. The internal circuitry may support various communication protocols, such as Bluetooth SMART and Wi-Fi. For Wi-Fi communication, the internal circuitry includes a wireless network interface controller that is compliant with Institute of Electrical and Electronics Engineers (IEEE) 802.11a/b/g/n standards.

According to one embodiment, the keyboard cover is tailored to match a specific make and a model of the tablet computer. The keyboard cover is made of a pliable material (e.g., soft polyurethane) that facilitates bending of the flexible strips and is suitable for protecting the tablet computer. In one embodiment, the pliable material prevents the display screen from physically contacting the keyboard while in the portability configuration.

According to one embodiment, the hand rest includes one or more additional touch pads associated with functions in addition to the touch pad. The additional touch pads may be programmed to operate as function keys. For example, the additional touch pads are user-programmable and enable the user to assign commands or operations to the additional touch pads. In one embodiment, the additional touch pads are programmed by a manufacturer to execute specific commands or operations associated with the tablet computer. The additional touch pads may be tailored to match the make and model of the tablet computer. In one embodiment, the additional touch pads are assigned to operate programs, stored in the tablet computer, that are intended for a specific user group (e.g., children, teens, adults) of the tablet computer. In one embodiment, the additional touch pads include symbols or markings to indicate their functions to the specific user group.

According to one embodiment, the back support and the hand rest include magnets that align to hold the hand rest against the back support in the portability configuration. In another embodiment, a suitable fastener is utilized to maintain the keyboard cover and the tablet computer in the portability configuration. In one embodiment, the suitable fastener includes, but is not limited to, a snap, a hook, a lock, or any other fastening material or hardware.

According to one embodiment, the base portion and the lower portion of the tablet computer include magnets that hold the lower portion in the desktop configuration. A variety of fasteners may be utilized to the hold the lower portion in the desktop configuration. In one embodiment, the tablet computer includes a sensor that detects when the tablet computer is positioned in the desktop configuration. In one embodiment, the sensor is configured to turn on and off the tablet computer and the keyboard when the lower potion is suitably positioned in the desktop configuration.

In one embodiment, the battery within the base portion is coupled with an internal battery of the tablet computer to increase the operating time of the tablet computer between charging sessions. In one embodiment, the battery has an appropriate storage capacity to increase the operating time of the tablet computer. In one embodiment, the storage capacity is suitable to at least double the operating time of the tablet computer.

According to one embodiment, the keyboard cover further includes one or more input and output ports. The input and output ports are preferably positioned at the back of the base portion. In one embodiment, the input and output ports include one or more universal serial bus (USB) ports. In one embodiment, a USB port is suitably configured to receive a power adapter cord that receives electrical power from a power outlet. The USB port supplies electrical power received from the power outlet to operate the keyboard and the tablet computer. In one embodiment, a USB port is configured to interface with peripheral devices via a USB cable. In other embodiments, the input and output ports provide serial communications channels for analog or digital communications.

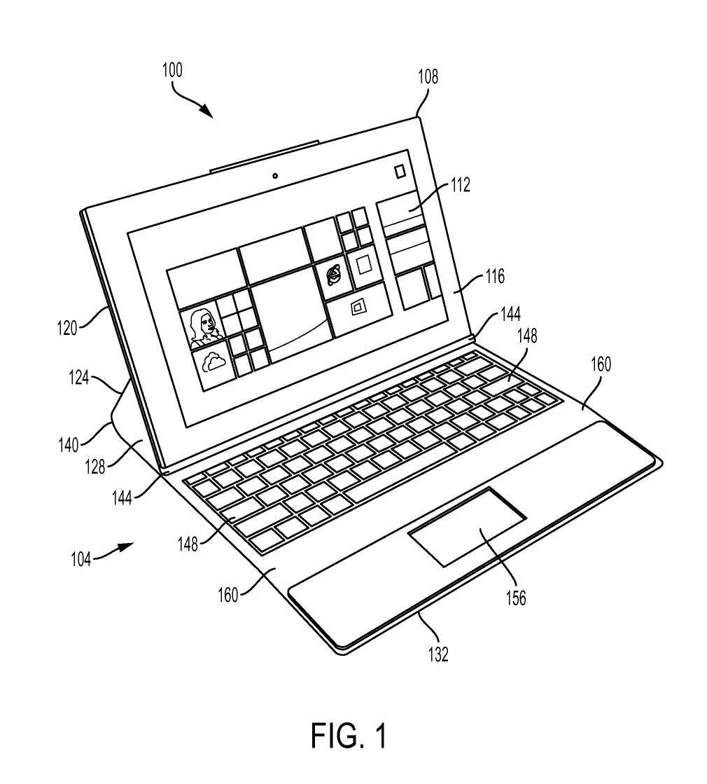

FIGS. 1-3 illustrate an exemplary desktop configuration of a keyboard cover, according to one embodiment. A keyboard cover 104 supports a tablet computer 108 in a desktop configuration 100. The tablet computer 108 includes a display screen 112 and an exterior case 116, a battery (not shown), at least one processor, and other internal circuitry typical of a tablet computer having a touch screen.

According to one embodiment, the tablet computer 108 and the keyboard cover 104 include internal wireless circuitry suitable for establishing a wireless connection between the keyboard cover 104 and the tablet computer 108. In one embodiment, the internal circuitry supports various communication protocols including, but not limited to, Bluetooth SMART and Wi-Fi. For Wi-Fi communication, the internal circuitry includes a wireless network interface controller (Wi-Fi) that is compliant with Institute of Electrical and Electronics Engineers (IEEE) 802.11a/b/g/n standard. In another embodiment, the keyboard cover 104 and the tablet computer 108 share a physical connection, such as a plug, to link the keyboard cover 104 directly to the tablet computer 108.

The keyboard cover 104 includes a back support 120, a brace 124, a base portion 128, and a hand rest 132. In one embodiment, the back support 120 fastens onto the rear side of the tablet computer 108 using snaps, or other fastening material or hardware. The keyboard cover 104 can be easily removed from the tablet computer 108 by unfastening the snaps. The back support 120 and the brace 124 share a flexible strip 136 that facilitates a rotational configuration of the back support 120 relative to the brace 124. Similarly, the brace 124 and the base portion 128 share a flexible strip 140 that facilitates a rotational configuration of the brace 124 relative to the base portion 128. Furthermore, a flexible strip 160, similar in construction to the flexible strips 136 and 140, connects the hand rest 132 with the base portion 128.

According to one embodiment, the keyboard cover 104 is made of a pliable material, such as soft polyurethane, or any other material that facilitates bending the flexible strips 136 and 140, and protecting the tablet computer 108 from impacts typically encountered during transport by the user. Although the keyboard cover 104 illustrated in FIGS. 1-3 includes the flexible strips 136,140, and 160, it will be appreciated that any of a variety of hinges and/or flexible adjoining member may be incorporated into the keyboard cover 104 in lieu of the strips 136, 140, and 160 without detracting from the present disclosure.

The base portion 128 further includes a keyboard 148, a battery 152, and internal circuitry configured to interface the keyboard 148 and the battery 152 with the tablet computer 108. As will be appreciated by those skilled in the art, coupling an appropriate size of the battery 152 with the battery inside the tablet computer 108 advantageously increases the operating time of the tablet computer 108 between charging sessions. In an embodiment, the battery 152 has a storage capacity suitable to at least double the operating time of the tablet computer 108.

The hand rest 132 includes a touch pad 156 that enables the user to interact with the tablet computer 108 using a finger. It is envisioned, however, that the hand rest 132 is not limited to the touch pad 156, but additional touch pads, buttons, keys, sensors, or input devices having various functions may be incorporated into the hand rest 132 in addition to the touch pad 156. In one embodiment, additional touch pads may be programmed to operate as function keys, in addition to the function keys of the keyboard 148. In other embodiments, the additional touch pads may be user-programmable and enable the user to assign frequently used favorites, commands or operations to the additional touch pads to quickly execute the assigned commands or operations. In other embodiments, the additional touch pads may be programmed by a manufacturer to execute specific commands or operations associated with the tablet computer 108. The additional touch pads may be tailored to match the make and model of the tablet computer 108. For example, where the tablet computer 108 is intended for a specific user group, such as young children, the additional touch pads may be assigned to operate, or interact with, specific programs intended for young children. Various other uses of the touch pad 156 and the additional touch pads will be apparent to those skilled in the art without detracting from the scope of the present disclosure.

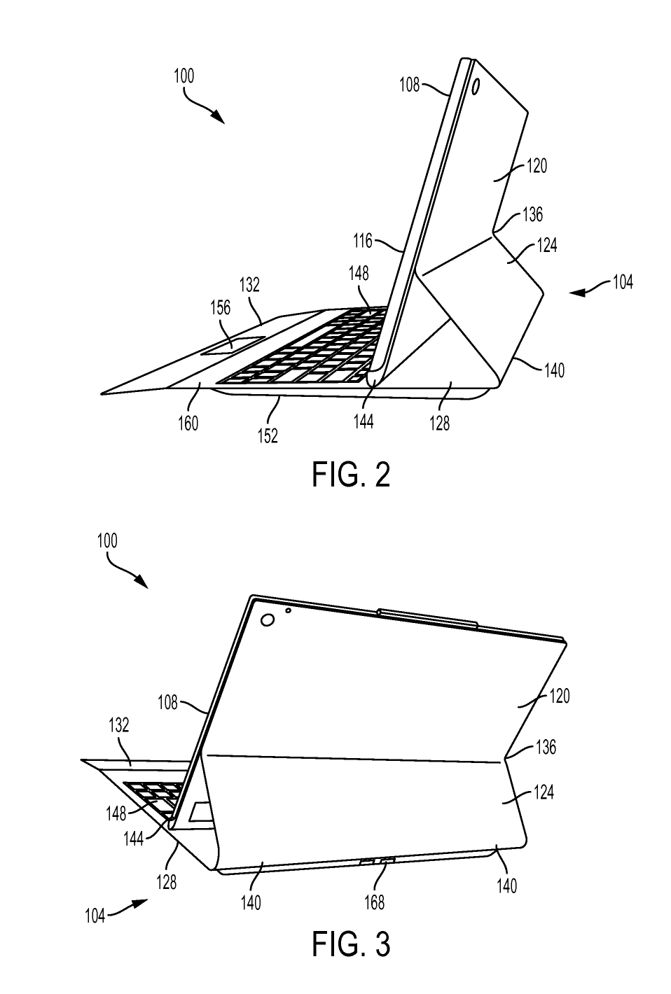

FIGS. 2 and 3 respectively illustrate a side view and a rear perspective view the keyboard cover configured in the desktop configuration, according to one embodiment. The back support 120 and the brace 124 are configured to support the rear side of the tablet computer 108 while the base portion 128 is configured to support a lower portion 144 of the tablet computer 108. The tablet computer 108 is maintained in a position suitable for viewing and interacting with the display screen 112 while allowing the user to simultaneously type on the keyboard 148 of the base portion 128. In one embodiment, the base portion 128 and the tablet computer 108 include magnets that hold the lower portion 144 of the exterior case 116 in the desktop configuration 100. In other embodiments, other types of fasteners may be utilized to the hold the lower portion 144 in the desktop configuration, as will be apparent to those skilled in the art.

According to one embodiment, the tablet computer 108 includes a sensor (not shown) to detect when the tablet computer 108 is positioned in the desktop configuration. The sensor may be configured to turn on the tablet computer 108, the keyboard 148, and the touch pad 156 when the lower potion 144 is suitably positioned in the desktop configuration. Further, the sensor may be configured to detect when the tablet computer 108 and the keyboard cover 104 are placed into a tablet configuration (not shown).

In a tablet configuration, the lower portion 144 is positioned toward the third flexible strip 160, the display screen 112 faces away from the keyboard 148, and the hand rest 132 is folded under the base portion 128. The keyboard cover may include another sensor (not shown) configured to detect when the tablet computer 108 and the keyboard cover 104 are placed into the tablet configuration. The sensor may switch the display screen 112 between a landscape format and a portrait format depending on the orientation of the tablet computer 108 while being held by the user. The sensor may be configured to turn off the tablet computer 108, the keyboard 148, and the touch pad 156 when the tablet computer 108 and the keyboard cover 104 are put into the portability configuration 164.

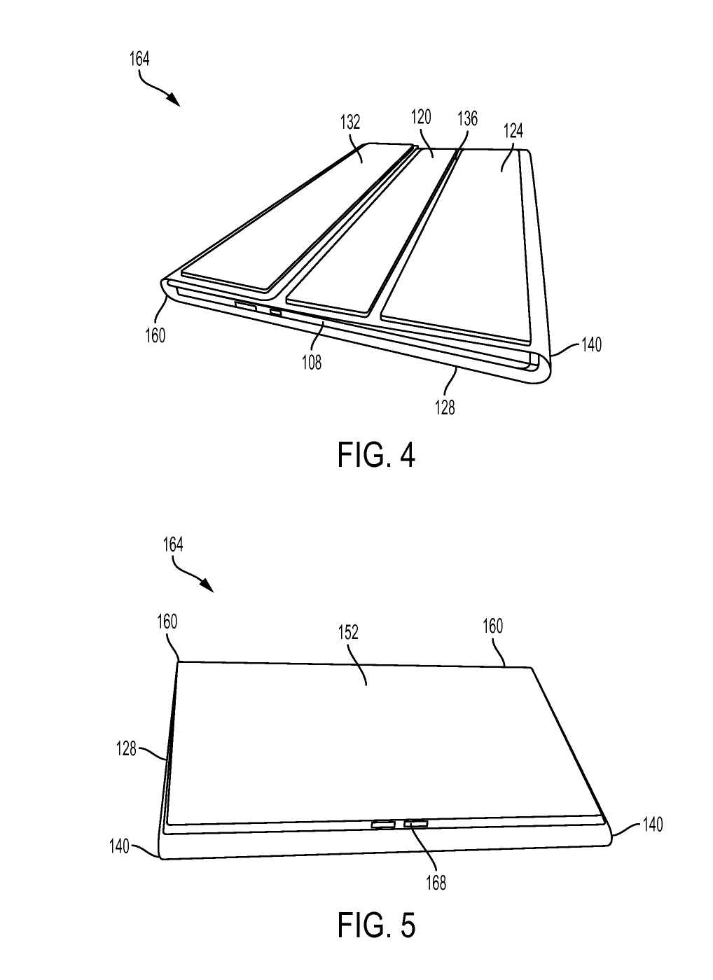

FIGS. 4 and 5 illustrate an exemplary portability configuration of the keyboard cover, according to one embodiment. In the portability configuration 164, the lower portion 144 is positioned against the inside of the flexible strip 140, and the display screen 112 faces toward the keyboard 148. The soft and pliable material of the keyboard cover 104 prevents the display screen 112 from physically contacting the keyboard 148 and protects the display screen 112 from damage due to scratching or impact. Once the tablet computer 108 is lying flat, the hand rest 132 is folded onto the back support 120 using the flexible strip 160. In one embodiment, the back support 120 and the hand rest 132 include internal magnets that align to hold the hand rest 132 in the portability configuration 164. In other embodiments, other suitable fasteners may be utilized to maintain the keyboard cover 104 and the tablet computer 108 in the portability configuration 164.

In the portability configuration, the keyboard cover 104 wraps around and covers the tablet computer 108, thereby protecting the tablet computer 108 from damage due to impacts typically encountered while the tablet computer 108 is being transported by the user. The portability configuration of the keyboard cover 104 further include a keyboard that is suitable for touch-typing without a burden of carrying the keyboard in addition to the tablet computer 108.

According to one embodiment, the keyboard cover 104 includes universal serial bus (USB) ports 168. In one embodiment, the USB ports 168 are suitably configured to receive a power adapter cord that receives electrical power from a power outlet and operate and charge the battery 152 as well as the internal battery of the tablet computer 108. The USB ports 168 may further supply the electrical power to operate the keyboard 148 and the tablet computer 108 from the power outlet and charge the battery 152 and the internal battery of the tablet computer 108. The USB ports 168 may be further configured to enable the user to connect a wide variety of peripheral devices to the tablet computer 108 via a USB cable. Preferably, the USB ports 168 are positioned at the back of the keyboard cover 104 so that cords and/or devices plugged into the ports do not interfere with the user and the user can comfortably operate the keyboard 148. It will be appreciated that the ports 168 are limited to USB ports, and other types of input and output ports may be utilized. For example, the ports 168 may be serial communications channels, such as, but not limited to, RS-232 ports, RS-485 ports, a CAN-bus, or any other type of port or channel suitable for analog or digital communications. Various configurations and uses of the ports 168 will be apparent to those skilled in the art without deviating from the spirit and scope of the present disclosure.

While some specific embodiments of the present disclosure have been shown, the present disclosure is not to be limited to these embodiments. The present disclosure is to be understood as not limited by the specific embodiments described herein, but only by scope of the appended claims.

1. An apparatus comprising:
a back support configured to be removably fastened onto a rear side of a tablet computer;
a brace that shares a first flexible strip with the back support, wherein the back support is rotatable along the first flexible strip relative to the brace;
a base portion that shares a second flexible strip with the brace, wherein the brace is rotatable along the second flexible strip relative to the base portion, and wherein the base portion includes a keyboard, a battery, and internal circuitry suitable for interfacing with the tablet computer; and
a hand rest that shares a third flexible strip with the base portion, wherein the hand rest is rotatable along the third flexible strip relative to the base portion, wherein the hand rest includes a touch pad;
wherein the apparatus is configurable in a desktop configuration, a tablet configuration, and a portability configuration.

2. The apparatus of claim 1, wherein in a desktop configuration, the back support and the brace of the apparatus support the rear side of the tablet computer while the base portion of the apparatus supports a lower portion of the tablet computer, maintaining the tablet computer in a position suitable for viewing and interacting with a display screen of the tablet computer while allowing the user to type on the keyboard.

3. The apparatus of claim 1, wherein in a tablet configuration, a lower portion of the tablet computer is positioned toward the third flexible strip, and the display screen of the tablet computer faces away from the keyboard, and the hand rest is folded under the base portion.

4. The apparatus of claim 1, wherein in a portability configuration, a lower portion of the tablet computer is positioned against an inside of the second flexible strip, the display screen of the tablet computer faces toward the keyboard, the hand rest is folded onto a back support using the third flexible strip, and the hand rest is fastened to the back support.

5. The apparatus of claim 1, wherein the apparatus is made of a pliable material that facilitates bending of the first, second, and third flexible strips, and is suitable for protecting the tablet computer.

6. The apparatus of claim 5, wherein the pliable material is soft polyurethane.

7. The apparatus of claim 1, wherein the back support and the hand rest include magnets that align to hold the hand rest against the back support in the portability configuration.

8. The apparatus of claim 1, further comprises a fastener to maintain the apparatus and the tablet computer in the portability configuration.

9. The apparatus of claim 1, wherein the hand rest comprises an additional touch pad programmed to operate as a function key.

10. The apparatus of claim 9, wherein the additional touch pad is assigned to operate programs stored in the tablet computer that are intended for a user group of the tablet computer.

11. The apparatus of claim 10, wherein the additional touch pad includes a symbol or marking to indicate a function to the specific user group.

12. The apparatus of claim 1, wherein the base portion and a lower portion of the tablet computer include a fastener that holds the lower portion in the desktop configuration.

13. The apparatus of claim 1, further comprises a sensor that detects when the tablet computer is positioned in the desktop configuration.

14. The apparatus of claim 1, wherein the apparatus further comprises input and output ports.

15. The apparatus of claim 14, wherein the input and output ports are positioned at a rear side of the base portion.

16. The apparatus of claim 14, wherein the input and output ports include a universal serial bus (USB) port configured to receive a power adapter cord.

17. The apparatus of claim 14, wherein the input and output ports are serial communications channels suitably configured for analog or digital communications.

18. The apparatus of claim 1, wherein the tablet computer and the apparatus comprise internal circuitry suitable for establishing a wireless connection therebetween.

19. The apparatus of claim 18, wherein the internal circuitry supports a Bluetooth protocol and Institute of Electrical and Electronics Engineers (IEEE) 802.11a/b/g/n standards.

20. The apparatus of claim 1, wherein the apparatus and the tablet computer share a physical connection, whereby the apparatus is directly connected to the tablet computer.
